(19) United States
(12) Patent Application Publication
(10) Pub. No.: US 2023/0362980 A1
(43) Pub. Date: Nov. 9, 2023

(54) RACH RESOURCE CONFIGURATION

(71) Applicant: Lenovo (Beijing) Limited, Beijing (CN)

(72) Inventors: Zhi Yan, Xicheng District (CN); Hongmei Liu, Changping District (CN); Yuantao Zhang, Dongcheng District (CN); Haiming Wang, Xicheng District (CN)

(73) Assignee: Lenovo (Beijing) Limited, Beijing (CN)

(21) Appl. No.: 18/041,441

(22) PCT Filed: Aug. 14, 2020
(86) PCT No.: PCT/CN2020/109205

§ 371 Date: Feb. 13, 2023

(51) Int. Cl. H04W 74/08; H04W 74/00

(52) U.S. Cl. CPC H04W 74/002; H04W 74/0833

(57) ABSTRACT

Methods and apparatuses for optimization of RACH procedure in non-terrestrial network are disclosed. A method comprises transmitting a preamble on a RACH resource from an uplink time slot, which is a first time advance before corresponding downlink time slot; and monitoring a control signal from a first time offset after the end of the transmission of the preamble.

### FIELD

The subject matter disclosed herein generally relates to wireless communications, and more particularly relates to methods and apparatuses for optimization of RACH procedure in non-terrestrial network (NTN).

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal) (UE), Physical Downlink Control Channel (PDCCH), Physical Downlink Shared Channel (PDSCH), Physical Uplink Shared Channel (PUSCH), Physical Uplink Control Channel (PUCCH), Physical Downlink Control Channel (PDCCH), timing advance (TA), non-terrestrial networks (NTN), terrestrial network (TN), Synchronization Signal and PBCH block (SSB), Random Access (RA), Random Access Response (RAR), Random Access Channel (RACH), RACH occasion (RO), Machine-Type Communication (MTC), enhanced MTC (eMTC), Internet-of-Things (IoT), Narrowband Internet-of-Things (NBIoT or NBIoT), Coverage Enhancement (CE), Global Navigation Satellite System (GNSS).

Random access procedure in NTN includes 4 steps as illustrated in FIG. 1. In step 1, when UE has location information and satellite (eNB or gNB) moving information, the UE can estimate distance of UE and eNB or gNB or timing advance (TA) (which is used to adjust the uplink frame timing relative to the downlink frame timing). Then, the UE transmits Msg1 (i.e. random access preamble) to gNB by applying the estimated TA. In step 2, the UE monitors Msg2 (i.e. random access response, which is the response to Msg1) transmitted from the gNB. Msg2 is also used to schedule Msg3 transmitted by the UE. According to the receiving of Msg2, the UE can make correction of TA (e.g. correction of the estimated TA). In step 3, the UE transmits Msg3 by applying the corrected TA. In step 4, the gNB receives Msg3 and derives UE-specific TA information, and then transmits Msg4 (response to Msg3) to the UE.

According to the random access procedure in NTN, even the UE with location information can estimate TA before transmitting Msg1, the estimated TA is not carried in Msg1. Therefore, the gNB has no knowledge of the TA when transmitting Msg2 (i.e. when scheduling Msg3). The TA information is carried only in Msg3. That is, the gNB gets to know the TA information when receiving Msg3. This is not favorable.

In the scenario of NTN, the TA can be very large due to long round-trip delay and can be wide range due to large cell range of NTN cell (footprint). The TA can be divided into common TA and UE-specific TA, where the whole TA is equal to the sum of the common TA and the UE-specific TA.

FIG. 2 illustrates the concept of the common TA and the UE-specific TA in NTN for two cases (for regenerative payload and for bent-pipe payload). The common TA is calculated with reference to a reference point, which can be determined as a terrestrial point right below the satellite. The value of common TA is determined by d0 for regenerative payload (i.e. the base station (eNB that is used in scenario of eMTC or NBIoT or gNB that is used in scenario of NR) is located on the satellite) and by dO+dO_F for bent-pipe payload (i.e. the base station (eNB or gNB) is located in a terrestrial place), in which d0 is a distance between the satellite and the reference point in the terrestrial and d0_F is a distance between the satellite and the terrestrial place where the base station is located. The value of UE-specific TA is determined by d1-d0, in which d1 is a distance between the satellite and the UE. As shown in FIG. 2, the UE-specific TA is 2*(d1-d0)/c, in which c is the speed of light; while the common TA (or common reference TA) is 2*d0/c for regenerative payload and is 2*(d0+d0_F)/c for bent-pipe payload.

As can be seen from the above, (d1-d0)/c, d0/c and (d0+d0_F)/c is a propagation delay. The timing advance is twice the value of the propagation delay. The whole TA for regenerative payload is 2*d0/c + 2*(d1-d0)/c = 2*d1/c; and the whole TA for bent-pipe payload is 2*(d0+d0_F)/c + 2*(d1-d0)/c = 2*(d1+d0_F)/c.

As the satellite can serves UE in a very large area in NTN, the TAs for different UEs can be quite different. It is obvious that the UE that is close to the satellite has a lower TA than the UE that is far away from the satellite within the same cell (footprint).

As described with reference to FIG. 1, after transmitting Msg1, the UE monitors Msg2. The time period during which the UE monitors Msg2 is referred to as RA Response Window. For NR, the start of the “RA Response Window” is configured at the first PDCCH occasion from the end of transmission of the Random Access Preamble (Msg1). For LTE, the start of the “RA Response Window” is configured at the subframe that contains the end of transmission of the Random Access Preamble (Msg1) plus three subframes, and has a length ra-ResponseWindowSize. If the UE is a Bandwidth reduced Low complexity (BL) UE or a UE in enhanced coverage, the “RA Response Window” starts at the subframe that contains the end of the last preamble repetition plus three subframes and has length ra-ResponseWindowSize for the corresponding coverage level.

In addition to the propagation delay, the estimated TA is also dependent on the processing delay by the UE and/or the base station. However, since the estimated TA is much longer than the processing delay in the scenario of NTN, the processing delay by the UE and the base station are not considered for ease of discussion. With reference to FIG. 3, suppose UE1 is right under the satellite and has the smallest TA (e.g. 2*min_delay) while UE2 is located in the farthest place that can be covered by the satellite and has the largest TA (e.g. 2*max_delay), the differential TA is determined as the largest TA minus the smallest TA (i.e. 2*max_delay -2*min_delay = 2 * maximum delay difference).

Since the distances between the base station (gNB or eNB) and different UEs are different (corresponding to different TAs), the UEs transmit their preambles with different TAs so that the preambles can reach the base station at the same time (with respect to the same RACH occasion (RO)). If the RO period (the interval between two consecutive RACH occasions) is not long enough compared to a large differential TA, the base station may make confusion on to which RO a specific preamble belongs.

FIG. 4 illustrates an example of the confusion of the eNB. The RO period is configured as 10 ms. For UE1, TA1 is 30 ms (delay1 is 15 ms); for UE2, TA2 is 50 ms (delay2 is 25 ms), and for UE3, TA3 is 30 ms (delay3 is 15 ms). The Msg1 transmitted by the UE is received by the eNB at RO2. As a result, the eNB may confuse whether the Msg1 corresponds to RO1 or to RO2.

A straightforward solution is to extend the RO period (the interval between two consecutive RACH occasions) to be larger than the maximum delay difference (which is equal to half of the differential TA) within the cell.

Another prior art solution to solve the problem of confusion is illustrated in FIG. 5. The preambles can be divided into groups (e.g. 2 groups) and mapped to different ROs, such that ROs with timing separation less than the maximum delay difference are always assigned with different groups of preambles. As illustrated in FIG. 5, the RO period is 30 ms: the first RO occasion is at 30 ms; the second RO occasion is at 60 ms; and the third RO occasion is at 90 ms. On the first RO occasion, it is assumed that only even preambles index (e.g. 0, 2, 4, ...) are configured as RACH resource; while on the second RO occasion, it is assumed that only odd preambles index (e.g. 1, 3, 5, ...) are configured as RACH resource. Therefore, each preamble index can be configured every two RO occasions, which suggests that the actual RO period for each preamble index is extended to twice of the RO period, which is larger than the maximum delay difference (i.e. half of the differential TA). Due to large differential TA, it is not easy to schedule Msg2 in the RAR window for UEs with similar TA ranges.

For RACH in eMTC or NBIoT, the RO period is configured per CE level. The RO period ranges from 2 to 256 ms for eMTC while from 40 to 2560 ms for NBIoT. eNB can configure up to 4 CE levels, which target for different coverages. For example, CE level 0 may correspond to preamble transmission with no repetition, while CE level 3 may correspond to preamble transmission with larger number of repetitions. The CE level is determined by RSRP threshold. In particular, the CE level number is equal to RSRP threshold number in higher layer parameter rsrp-ThresholdsPrachInfoList plus 1 (e.g. TH1, TH2). If rsrp-ThresholdsPrachInfoList is not present, only 1 CE level is configured. If only one threshold (e.g. TH1) is configured in rsrp-ThresholdsPrachInfoList, 2 CE levels are configured, i.e. if RSRP is larger than TH1, CE level is 0; otherwise (if RSRP is smaller than TH1), CE level is 1. If two one thresholds (e.g. TH1 and TH2) are configured in rsrp-ThresholdsPrachInfoList, 3 CE levels are configured, i.e. if RSRP is larger than TH1, CE level is 0; if RSRP is larger than TH2 and smaller than TH1, CE level is 1, otherwise (if RSRP is smaller than TH2), CE level is 1. In summary, the total number of CE level(s) is determined by the number of RSRP threshold(s), and the RACH resource is configured per CE level. As shown in FIG. 6, RSRP is measured as a basis to determine the CE level. The RACH resource is determined for each CE level. Based on the determined RACH resource, the preamble (i.e. Msg1) is transmitted.

GNSS capability in the UE is now taken as a working assumption in both NBIoT and eMTC devices. Therefore, UE has the ability of estimating timing and frequency offsets with sufficient accuracy.

This invention targets for TA, RACH resource, RACH coverage, RAR window determination and full TA information indication in RACH procedure for eMTC/NBIoT/NR over NTN for UE with location information.

### BRIEF SUMMARY

Methods and apparatuses for optimization of RACH procedure in non-terrestrial network are disclosed.

In one embodiment, a method comprises transmitting a preamble on a RACH resource from an uplink time slot, which is a first time advance before corresponding downlink time slot; and monitoring a control signal from a first time offset after the end of the transmission of the preamble.

In one embodiment, the first time advance is carried in the preamble. The RACH resource is determined by one of the first time advance, a round trip delay, a distance of UE and a base unit and a propagation delay and the threshold(s) therefor. The threshold(s) may be determined by at least one of a RO period and a minimal first time advance. The threshold(s) may be configured by higher layer signaling.

In another embodiment, the first time advance is determined by at least one of a round trip delay, a time advance offset, a distance of UE and a base unit, a propagation delay, and a processing delay. The first time offset is determined by at least one of the first time advance, a round trip delay, a time advance offset, a distance of UE and a base unit, a propagation delay, and a processing delay.

In some embodiment, the method further comprises transmitting a second time advance in an uplink signal, the second time advance is derived from at least one of the first time advance, threshold(s) for the first time advance and a corrected time advance.

In some embodiment, the RACH resource includes at least one of a preamble sequence index, a Random Access occasion index, a subcarrier index in a RACH carrier, a RACH carrier type and a RACH carrier index. The RACH resource may be associated with a coverage level, the coverage level is determined at least based on one of the first time advance, a round trip delay, a distance between UE and a base unit and a propagation delay and the threshold(s) therefor.

In another embodiment, a remote unit comprises a transmitter that transmits a preamble on a RACH resource from an uplink time slot, which is a first time advance before corresponding downlink time slot; and a processor that monitors a control signal from a first time offset after the end of the transmission of the preamble.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a legacy random access procedure;

FIG. 2 illustrates the concept of the common TA and the UE-specific TA in NTN for two cases;

FIG. 3 illustrates an example of different TAs for different UEs;

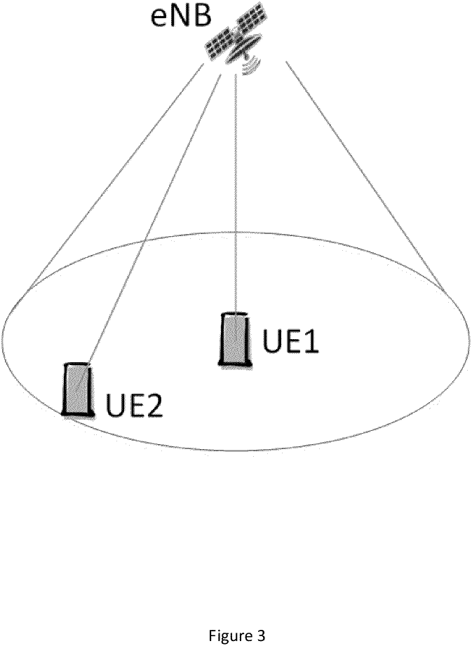

FIG. 4 illustrates an example of the confusion of the eNB;

FIG. 5 illustrates a prior art solution to solve the problem of confusion;

FIG. 6 illustrates a legacy CE level determination for determining RACH resource;

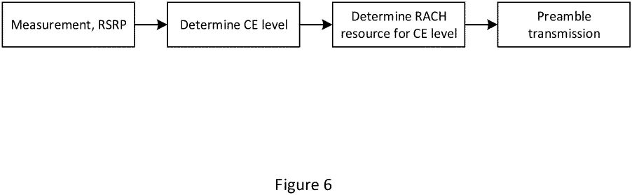

FIG. 7 illustrates a timing sequence of transmitting and receiving Msg1 and Msg2;

FIG. 8 illustrates the concept of the second embodiment;

FIG. 9 illustrates the determination of CE level according to the third embodiment;

FIG. 10 is a schematic flow chart diagram illustrating an embodiment of a method; and

FIG. 11 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user’s computer, partly on the user’s computer, as a stand-alone software package, partly on the user’s computer and partly on a remote computer or entirely on the remote computer or server. In the very last scenario, the remote computer may be connected to the user’s computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

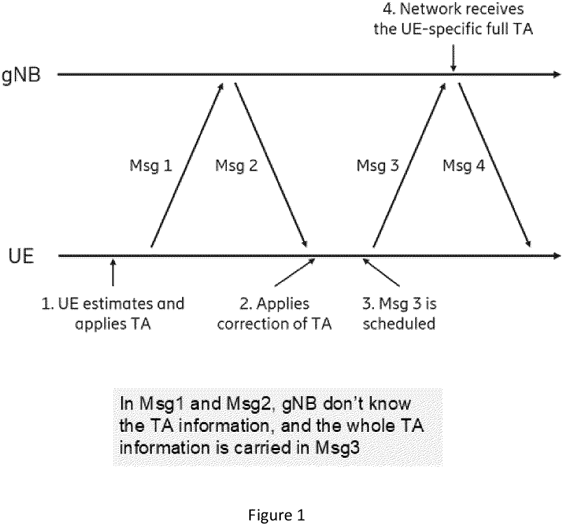

The random access procedure according to a first embodiment includes the same four steps as illustrated in FIG. 1. The detailed implementations are enhanced.

When the UE has location information, the UE transmits the preamble (Msg1) in a uplink slot, which is a time advance before corresponding downlink slot. The time advance is calculated by UE itself and can be referred to as estimated TA.

The estimated TA is explained in detail. Actually, the time advance (referred to as total TA) can be classified as estimated TA and TA offset. In particular, the total TA is equal to the sum of the estimated TA and the TA offset. The TA offset depends on the duplex mode of the cell in which the uplink transmission takes place and the frequency range (FR), which is mainly for Tx/Rx switching. The value of the TA offset (N_{TAoffset}) is shown in the following table:

TABLE 7.1.2-2

The Value of N_{TA} _{offset}

| Frequency range and band of cell used for uplink transmission | N_{TA} _{offset} (Unit T_{c}) |
|---|---|
| FDD in FR1 | 0 |
| FR1 TDD band | 39936 or 25600 (Note 1) |
| FR2 | 13792 |

NOTE 1: The UE identifies N_{TA offset} based on the information [TBD] according to [TS38.331].
NOTE 2: The value of N_{TA} _{offset} that applies to the supplementary UL carrier is determined from the non-supplementary UL carrier.

The TA offset only applies the scenario of NR (in NTN) but does not apply to the scenario of eMTC or NBIoT (in NTN).

The TA offset can be compensated by the base station. For example, when the base station configures the RACH occasion, the TA offset maybe considered. In this condition or in the condition when the TA offset does not apply, from the UE point of view, the total TA is equivalent to the estimated TA.

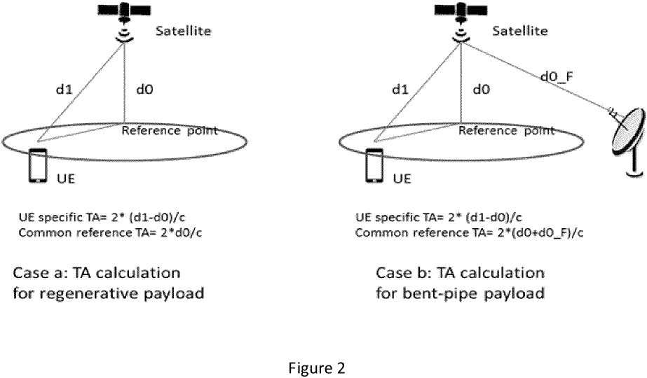

The estimated TA is dependent on the propagation delay and the processing delay. The propagation delay is dependent on the distance between the base station and UE. For example, as illustrated in FIG. 2, the distance between the base station and UE is d1 for regenerative payload and is d1+d0_F for bent-pipe payload. The propagation delay can be obtained by dividing the distance between the base station and UE by the speed of light (c). Since the speed of light is a constant, the propagation delay and the distance between the base station and UE are interchangeable. That is, one of the propagation delay and the distance between the base station and UE is determined, the other is determined. The estimated TA is twice of the propagation delay plus the processing delay.

The processing delay can be processing delay by UE and/or processing delay by base station. The processing delay by UE and/or the processing delay by base station may be dynamically configured or configured as a fixed value. For example, a fixed processing delay by the base station (e.g. 3 ms) is used in the scenario of eMTC or NBIoT (eMTC or NBIoT in NTN). The processing delay by UE and/or the processing delay by base station may also be compensated by the base station. In this condition, from the UE point of view, the estimated TA is only dependent on the propagation delay (or the distance between the base station and UE), for example, equal to twice of the propagation delay.

Twice of the propagation delay may be referred to as a round trip delay. In some condition, the round trip delay may refer to twice of the propagation delay plus the processing delay.

As a whole, the total TA is equal to the sum of the estimated TA and the TA offset. If the TA offset does not apply or is compensated by the base station, the estimated TA can be regarded as the total TA from the UE point of view. The estimated TA is equal to the sum of twice of the propagation delay plus the processing delay (by UE and/or by base station). If either or both of the processing delay by UE and the processing delay by base station are compensated by the base station, it is (they are) not considered in the estimated TA. The round trip delay may refer to twice of the propagation delay or the sum of the propagation delay and the processing delay.

As described above, in different conditions, the estimated TA may have different meanings. In a word, the estimated TA refers to the TA that has to be considered at the UE side.

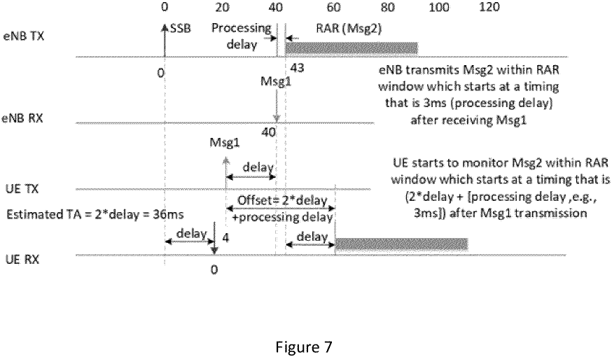

FIG. 7 illustrates a timing sequence of transmitting and receiving Msg1 and Msg2 in the scenario of eMTC or NBIoT (in NTN). The values adopted in FIG. 7 are only illustrative. In FIG. 7, the TA offset (N_{TAoffset}) does not apply and accordingly is assumed to be 0 from the UE point of view. The processing delay by UE is not considered in this example (it is irrelevant in this example). The processing delay by eNB (i.e. base station) is assumed to be 3 ms.

At a timing of 0 ms (downlink subframe 0), a SSB is transmitted from eNB. The SSB indicates that an RO occasion starts at 40 ms (subframe 40). The UE receives the SSB at certain timing corresponding to downlink subframe 0. The UE can make an estimation of the TA by itself based on the location information. Suppose that the estimated propagation delay is 18 ms. Therefore, in this example, the total TA (N_{TA}) is equal to the estimated TA, which is twice of the propagation delay (i.e. 2*18 = 36 ms). That means that the UE would transmit the preamble (Msg1) at a timing of 40-36=4 ms corresponding to downlink subframe, starting from the timing when the SSB is received (corresponding to downlink subframe 0), so that the Msg1 can be received at the eNB at the timing of 40 ms.

The UE starts to monitor PDCCH after an offset of transmitting Msg1. The offset refers to a period from the timing of completing transmitting Msg1 to the start of the “RA Response Window”. The UE monitors RAR (i.e. Msg2, which is the response to Msg1) during the “RA Response Window”. The offset is determined by at least one of (1) the total TA (N_{TA}) adopted in Msg1 transmission, (2) the estimated TA, (3) the TA offset, (4) the propagation delay or the distance between the UE and the eNB, and (5) the processing delay. In the example of FIG. 7, the offset is the sum of (1) the estimated TA (which is twice of the propagation delay) and (2) the processing delay by eNB (which assumed to be a fixed processing delay (e.g. 3 ms that is used in the scenario of eMTC or NBIoT (in NTN)).

The eNB receives the Msg1 at the timing of 40 ms. After the fixed processing delay (e.g. 3 ms), the eNB transmits Msg2 within a RAR window starting from the timing of 43 ms (=40+3). The UE expects to receives the Msg2 in a “RA Response Window” starting from a timing that is the offset (e.g. the sum of the 2* propagation delay (36 ms) and the fixed processing delay) (3 ms), i.e. 39 ms) from completing transmitting the Msg1.

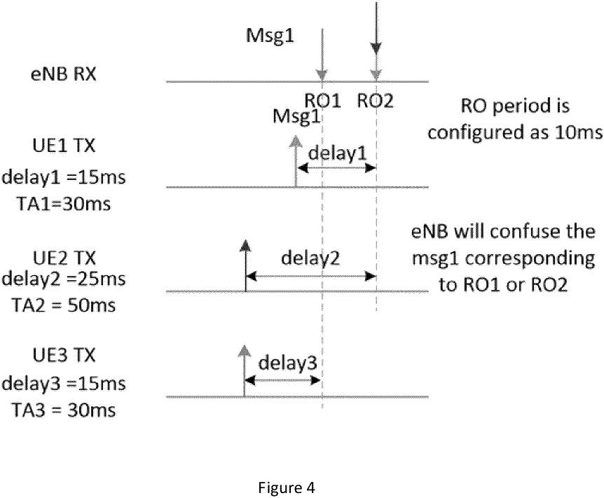

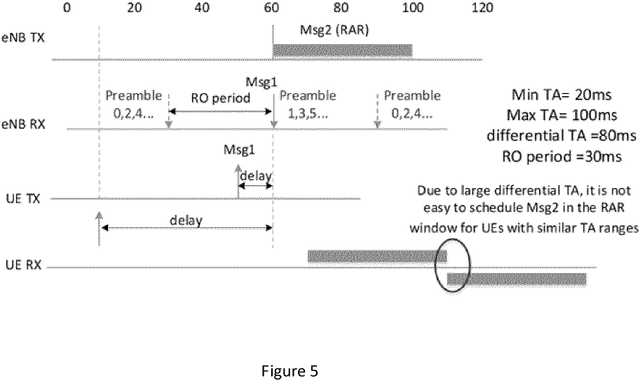

The second embodiment aims to solve the potential problem of confusion of RACH occasions (ROs). As illustrated in FIG. 4, the eNB may confuse the ROs due to the limitation of the RO period (small RO period compared with large differential TA (or compared with large maximum delay difference)). According to the prior art solution described with reference to FIG. 5, the actual RO period is extended to twice of the RO period. It is not favorable. In FIG. 5, each RACH resource is identified by its preamble sequence index. In addition to the preamble sequence index, the RACH resource can alternatively be any of: a Random Access occasion index, a subcarrier index in a RACH carrier, a RACH carrier type, and a RACH carrier index. For simplicity, the following description still takes the preamble sequence index as an example of the RACH resource.

According to the second embodiment, the RACH resource is determined by the comparison of the estimated TA with a threshold (or with multiple thresholds). As described above, the estimated TA may be different in different conditions. As a result, the parameter to be compared with the threshold(s) may alternatively be any of the total TA, the propagation delay, the distance between UE and base station.

With reference to FIG. 1, according to prior art random access procedure, the estimated TA is not carried in Msg1. So, the eNB does not know the estimated TA after receiving the Msg1, and accordingly may confuse to which RO occasion the Msg1 belongs.

According to the second embodiment, initial TA information (i.e. the estimated TA by the UE) is carried in Msg1. Therefore, the UE knows the estimated TA when transmitting Msg1, and the eNB also knows the estimated TA after receiving the Msg1.

According to the value of the estimated TA, the UE can estimate when the Msg1 will be received by the eNB; and the eNB can estimate when the Msg1 was transmitted by UE and accordingly assume to which RO occasion the Msg1 belongs.

A threshold can be configured to distinguish the preambles (Msg1) with different estimated TAs. For example, the threshold can be configured by a higher layer signaling, e.g. as 2* RO period plus minimal TA. For another example, the threshold can be directly configured by the higher layer signaling as a value with a unit of millisecond.

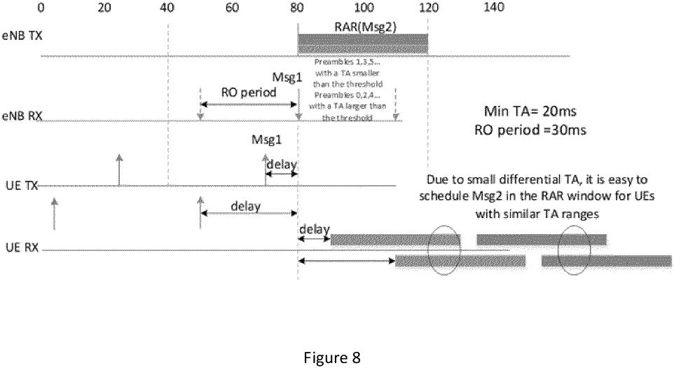

FIG. 8 illustrates the concept of the second embodiment. In FIG. 8, the RO period is 30 ms, and the minimal TA is 20 ms. For ease of discussion, each of the TA offset, the processing delay by UE and the processing delay by eNB (by base station) is assumed to be 0.

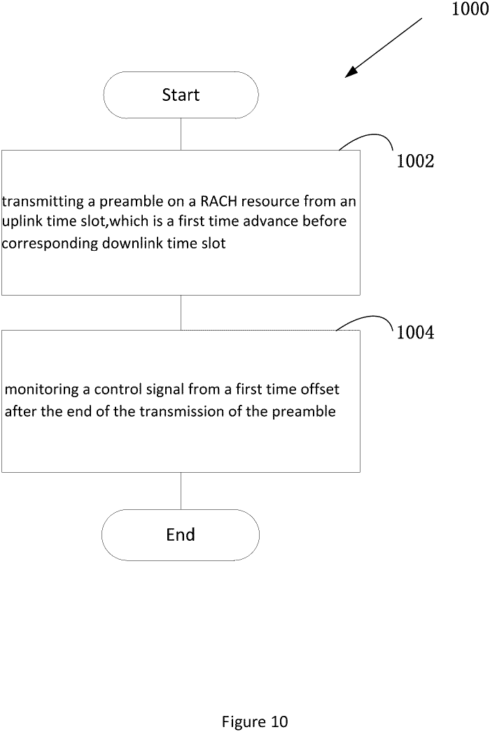

The RO occasions are assumed to be at 50 ms (first RO occasion), 80 ms (second RO occasion), 110 ms (third RO occasion), etc, with a RO period of 30 ms. The threshold for the estimated TAs to distinguish different preambles (Msg1) is configured as 2* RO period plus minimal TA, i.e. 2*30+20 = 80 ms. From the point of view of propagation delay (which is half of the estimated TA in this example), the threshold for the estimated TA being 80 ms is equivalent to the threshold for the estimated propagation delay being 40 ms. Therefore, as shown in FIG. 10, the dashed lines aligning with 40 ms, 80 ms and 120 ms represent the thresholds for the estimated propagation delays. Among the RACH resources to be received at the second RO occasion (at timing of 80 ms), a part of the RACH resources with an estimated TA that is smaller than the threshold (e.g. the preambles with odd preamble sequence indices (e.g. 1, 3, 5, ...)) are considered to be in one group. On the other hand, the other part of the RACH resources with an estimated TA that is larger than the threshold (e.g. the preambles with even preamble sequence indices (e.g. 0, 2, 4, ...)) are considered to be in the other group.

Since the UE knows the estimated TA, the UE knows the timing when the preamble it transmits will be received by the eNB, and accordingly knows the transmitted preamble would belong to which RO occasion. Because the preambles with different estimated TAs are grouped based on the comparison of the estimated TAs with the threshold, the preambles in the same group will have smaller differential TA compared with the grouping without considering estimated TAs in the prior art shown in FIG. 5. For example, in FIG. 5, when the Max TA is 100 ms (and the Min TA is 20 ms), the differential TA would be 80 ms. On the other hand, as the threshold is configured as 80 ms (and the Min TA is 20 ms) in the example of FIG. 8, the differential TA becomes 60 ms for the group of RACH resources with a TA that is smaller than the threshold. Due to small differential TA, it is easy to schedule Msg2 in the RAR window for UEs with similar TA ranges.

In the example of FIG. 8, one threshold for the estimated TAs is configured. In a variety of the second embodiment, two or more thresholds for the estimated TAs can be configured. For example, when two thresholds, e.g. a first threshold (e.g. 4* RO period plus minimal TA) and a second threshold (e.g. 2* RO period plus minimal TA), are configured, if an estimated TA of a UE is larger than the first threshold, the UE is assumed to be configured in RACH resource group 1 (e.g. the preambles with preamble sequence indices 0, 3, 6, ...); if the estimated TA of a UE is larger than the second threshold and smaller than the first threshold, the UE is assumed to be configured in RACH resource group 2 (e.g. the preambles with preamble sequence indices 1, 4, 7, ...); and otherwise (if the estimated TA of a UE is smaller than the second threshold), the UE is assumed to be configured in RACH resource group 3 (e.g. the preambles with preamble sequence indices 2, 5, 8, ...). The minimal TA, the first threshold and the second threshold can be configured by higher layer. In the above example, the threshold(s) are determined by the RO period and the minimal TA (e.g. calculated as 4* RO period plus minimal TA, and 2* RO period plus minimal TA). The threshold(s) may be alternatively directly configured by a higher layer signaling as a value with a unit of millisecond. For example, three thresholds (e.g. TA1, TA2, TA3) can be configures as TA1 = 30 (ms), TA2 = 60 (ms), and TA3 = 90 (ms).

As another variety of the second embodiment, the RACH resource may not be preamble sequence indices. For example, the RACH resource may be RACH carrier type which may be non-anchor carrier or anchor carrier. If the estimated TA is larger than a threshold, the non-anchor carrier is the carrier for RACH, otherwise (if the estimated TA is smaller than the threshold), the anchor carrier is the carrier for RACH.

According to yet another variety of the second embodiment, the number of RACH resources in a group may not be the same. For example, if the estimated TA is larger than a threshold, all preambles of odd RO occasion and even preamble indices (e.g. 0, 2, 4, ...) of even RO occasion are configured in one group, otherwise (if the estimated TA is smaller than the threshold), odd preamble indices (e.g. 1, 3, 5, ...) of even RO occasion are configured in the other group.

As the RACH resources are grouped according to a comparison of different estimated TAs with the threshold(s) therefor, the TA information in Msg3 scheduled by Msg2 can be based on the reference TA corresponding to the RO (i.e. the threshold(s) for the estimated TAs). In particular, the TA information may be derived from the estimated TA, corrected TA in Msg2 and threshold(s) for the estimated TAs. For example, if estimated TA is smaller than the threshold “2* RO period plus minimal TA”, RACH resource is configured in RACH resource group 1, and the TA information in Msg3 is also based on the threshold “2* RO period plus minimal TA” which is the maximum TA for the RACH resources in RACH resource group 1. Therefore, compared with prior art in which the TA information in Msg3 is based on the maximum TA, shorter differential TA range that can be indicated by less bits is achieved. For example, assuming that the maximal TA is 180 ms and the minimal TA is 20 ms. When no threshold(s) are configured, the TA information in all Msg3 scheduled by Msg2 is scheduled based on the maximal TA with a range of the maximal TA minus the minimal TA (that is 160 ms). On the other hand, when thresholds (e.g. TA1=80 ms and TA2=140 ms) are configured, the TA information in Msg3 for the UE with estimated TAs larger than 140 ms can be scheduled based on the maximal TA with a range of the maximal TA minus TA2 (that is 40 ms); the TA information in Msg3 for the UE with estimated TAs larger than 80 ms and smaller than 140 ms can be scheduled based on the threshold TA2 (=140 ms) with a range of TA2 minus TA1 (that is 60 ms); and the TA information in Msg3 for the UE with estimated TAs smaller than 80 ms can be scheduled based on the threshold TA1 (=80 ms) with a range of TA1 minus the minimal TA (that is 60 ms). Therefore, the differential TA range can be reduced from 160 ms to 60 ms.

According to a third embodiment, the CE level is determined with reference to TA information, e.g. one of the estimated TA, the round trip delay, the distance between UE and a base station and a propagation delay, by comparing the TA information with configured threshold(s) for the TA information. In the following example, the TA information is the estimated TA.

Line of sight (LOS) is a normal scenario of eMTC or NBIoT in NTN. That is to say, RSRP is largely determined by the distance between satellite and UE (e.g. TA). Therefore, it is reasonable to configure different TAs to different coverage (CE level).

For example, a TH1 is configured as a threshold for RSRP and a TA1 is configured as a threshold for TA. If RSRP > TH1 and TA<TA1, coverage 0 is determined; if RSRP > TH1 and TA > TA1, coverage 1 is determined; if RSRP < TH1 and TA < TA1, coverage 2 is determined; and if RSRP < TH1 and TA > TA1, coverage 3 is determined.

For another example, TA1, TA2 and TA3 (TA1< TA2 < TA3) are configured as thresholds for TA. If TA < TA1, coverage 0 is determined; if TA1 < TA < TA2, coverage 1 is determined; if TA2 < TA < TA3, coverage 2 is determined; and if TA > TA3, coverage 3 is determined.

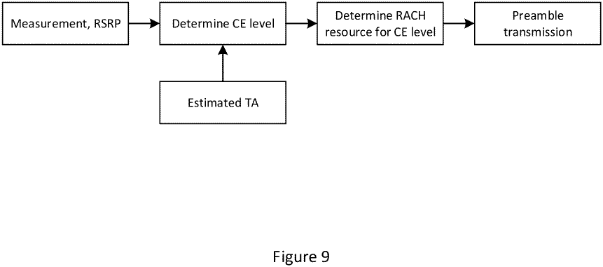

Therefore, as illustrated in FIG. 9, the coverage can be determined by a combination of RSRP and estimated TA, or only by estimated TA. The RACH resource is configured per coverage (i.e. CE level). Based on the determined RACH resource, the preamble (i.e. Msg1) is transmitted.

FIG. 10 is a schematic flow chart diagram illustrating an embodiment of a method 1000 according to the present application. In some embodiments, the method 1000 is performed by an apparatus, such as a remote unit. In certain embodiments, the method 1000 may be performed by a processor executing program code, for example, a microcontroller, a microprocessor, a CPU, a GPU, an auxiliary processing unit, a FPGA, or the like.

The method 1000 may include 1002 transmitting a preamble on a RACH resource from an uplink time slot, which is a first time advance before corresponding downlink time slot; and 1004 monitoring a control signal from a first time offset after the end of the transmission of the preamble.

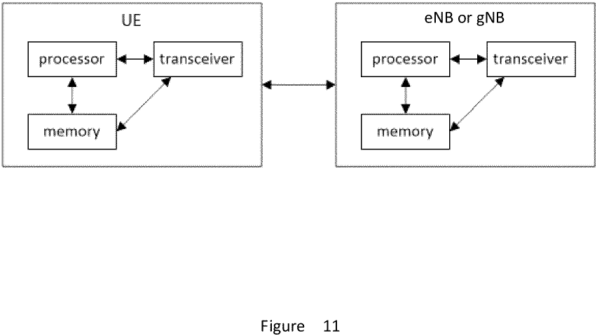

FIG. 11 is a schematic block diagram illustrating apparatuses according to one embodiment.

Referring to FIG. 11, the UE (i.e. the remote unit) includes a processor, a memory, and a transceiver. The processor implements a function, a process, and/or a method which are proposed in FIG. 10. The eNB or gNB (i.e. base unit) includes a processor, a memory, and a transceiver. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method, comprising:
transmitting a preamble on a random access channel (RACH) resource from an uplink time slot, which is a first time advance before a corresponding downlink time slot; and
monitoring a control signal from a first time offset after an end of the transmitting of the preamble.

2. The method of claim 1, wherein the first time advance is carried in the preamble.

3. The method of claim 1, wherein the first time advance is determined by at least one of a round trip delay, a time advance offset, a distance between a user equipment (UE) and a base unit, a propagation delay, or a processing delay.

4. The method of claim 1, wherein the first time offset is determined by at least one of the first time advance, a round trip delay, a time advance offset, a distance between a user equipment (UE) and a base unit, a propagation delay, or a processing delay.

5. The method of claim 1, wherein the RACH resource includes at least one of a preamble sequence index, a random access occasion index, a subcarrier index in a RACH carrier, a RACH carrier type, or a RACH carrier index.

6. The method of claim 1, wherein the RACH resource is determined by one of the first time advance, a round trip delay, a distance between a user equipment (UE) and a base unit, or a propagation delay .

7. The method of claim 6, wherein the one or more of a first time advance threshold, a round trip delay threshold, a distance threshold, or a propagation delay threshold are determined by at least one of a RACH occasion (RO) period, or a minimal first time advance.

8. The method of claim 6, wherein one or more of a first time advance threshold, a round trip delay threshold, a distance threshold, or a propagation delay threshold are configured by higher layer signaling.

9. The method of claim 1, further comprising: transmitting a second time advance in an uplink signal, the second time advance derived from at least one of the first time advance, one or more thresholds for the first time advance, or a corrected time advance.

10. The method of claim 1, wherein the RACH resource is associated with a coverage level, the coverage level determined at least based on one of the first time advance, a round trip delay, a distance between a user equipment (UE) and a base unit, a propagation delay, a first time advance threshold, a round trip delay threshold, a distance threshold, or a propagation delay threshold.

11. An apparatus, comprising:
a transmitter;
a processor coupled to a memory; and
the processor coupled to the transmitter configured to cause the apparatus to:
transmit a preamble on a random access channel (RACH) resource from an uplink time slot, which is a first time advance before a corresponding downlink time slot; and
monitor a control signal from a first time offset after an end of the preamble transmit.

12. The apparatus of claim 11, wherein, the first time advance is carried in the preamble.

13. The apparatus of claim 11, wherein the first time advance is determined by at least one of a round trip delay, a time advance offset, a distance between the apparatus and a base unit, a propagation delay, or a processing delay.

14. The apparatus of claim 11, wherein the first time offset is determined by at least one of the first time advance, a round trip delay, a time advance offset, a distance between the apparatus and a base unit, a propagation delay, or a processing delay.

15. The apparatus of claim 11, wherein the RACH resource includes at least one of a preamble sequence index, a random access occasion index, a subcarrier index in a RACH carrier, a RACH carrier type, or a RACH carrier index.

16. The apparatus of claim 11, wherein the RACH resource is determined by one of the first time advance, a round trip delay, a distance between the apparatus and a base unit, or a propagation delay .

17. The apparatus of claim 16, wherein one or more of a first time advance threshold, a round trip delay threshold, a distance threshold, or a propagation delay threshold are determined by at least one of a RACH occasion (RO) period, or a minimal first time advance.

18. The apparatus of claim 16, wherein one or more of a first time advance threshold, a round trip delay threshold, a distance threshold, or a propagation delay threshold are configured by higher layer signaling.

19. The apparatus of claim 11, wherein the processor coupled to the transmitter is configured to cause the apparatus to transmit a second time advance in an uplink signal, the second time advance derived from at least one of the first time advance, one or more thresholds for the first time advance, or a corrected time advance.

20. The apparatus of claim 11, wherein the RACH resource is associated with a coverage level, the coverage level determined at least based on one of the first time advance, a round trip delay, a distance between the apparatus and a base unit, a propagation delay, a first time advance threshold, a round trip delay threshold, a distance threshold, or a propagation delay threshold.
